(19) United States
(12) Patent Application Publication
(10) Pub. No.: US 2022/0325027 A1
(43) Pub. Date: Oct. 13, 2022

(54) ACID-RESISTANT AND ALKALI-RESISTANT COMPOSITION

(71) Applicant: Covestro Intellectual Property GmbH & Co. KG, Leverkusen (DE)

(72) Inventors: Yun Chu, Pudong, Shanghai (CN); Zhirong Fan, Langenfeld (DE); Xutian Liang, Pudong, Shanghai (CN); Xuedong Li, Pudong, Shanghai (CN)

(21) Appl. No.: 17/642,750

(22) PCT Filed: Sep. 23, 2020
(86) PCT No.: PCT/EP2020/076469

§ 371 Date: Mar. 14, 2022

(30) Foreign Application Priority Data
Sep. 30, 2019 (CN) 201910939340.3

(51) Int. Cl. C08G 18/44; C08G 18/08; C08G 18/12; D06M 15/568

(52) U.S. Cl. CPC C08G 18/44; C08G 18/0823; C08G 18/0828; C08G 18/0866; C08G 18/12; D06M 15/568

(57) ABSTRACT

The present invention relates to an acid-resistant and alkali-resistant composition, a preparation process thereof and use thereof in producing an article, and an article comprising a substrate coated or impregnated with the same and the preparation method and use of the article. The composition contains: at least one aqueous polyurethane dispersion having a carboxyl group; at least one crosslinking agent having an isocyanate reactive group; at least one crosslinking agent having a carboxyl reactive group; and optionally an additive; wherein, the amount of the carboxyl groups in said aqueous polyurethane dispersion is more than 0.05 wt %, based on the amount of said aqueous polyurethane dispersion being 100 wt %; the amount of said crosslinking agent having an isocyanate reactive group is 0.2 wt %-10 wt %, based on the amount of said composition being 100 wt %; the molar ratio of the carboxyl reactive groups to the carboxyl groups of said composition is more than 0.5. The film formed with the composition of the present invention has good acid-resistance and alkali-resistance. The product obtained by treating with the composition of the present invention has flat appearance and good handfed.

### TECHNICAL FIELD

The present invention relates to an acid-resistant and alkali-resistant composition, a preparation process thereof and use thereof in producing an article, and an article comprising a substrate coated or impregnated with the same and the preparation method and use of the article.

### BACKGROUND

The superfine fiber, namely the fiber with the fineness of less than 0.3 denier (the diameter is 5 microns), has the characteristics of structure simulation, high air permeability, good soft handfeel, high physical and mechanical properties and the like, is one of ideal substitute materials for genuine leather, and can be applied to the fields of decoration, automotive, bags, shoes, clothing and the like.

Superfine fibers generally need to be impregnated with polyurethane to obtain plump and elastic handfeel. Solvent-type polyurethane (polyurethane dimethylformamide solution) is widely used in the industry. However, the dimethylformamide (DMF) solution is toxic and has a carcinogenic risk, so attempts have been made to impregnate ultrafine fibers with aqueous polyurethane dispersions.

In recent years, the sea-island type bicomponent superfine fiber products using polyester (PET) as an island component and alkali-soluble polyester (Co-PET) as a sea component, nylon (Nylon) as an island component and alkali-soluble polyester (Co-PET) as a sea component, or polyester (PET) as an island component and polyvinyl alcohol (PVA) as a sea component have appeared in the market. Since only hot alkali or hot water is only needed for fiber opening rather than the solvent such as toluene and the like, it is more environment-friendly and is more and more favored by the market. Such a process requires a film formed with the aqueous polyurethane dispersion to have excellent hot alkali-resistance. Furthermore, the superfine fiber product sometimes may need to be dyed after fiber opening to obtain better appearance and use performance, and the dyeing process usually requires high-temperature acidic conditions, which also poses a high challenge to the hot acid-resistance of the film formed with the aqueous polyurethane dispersion for impregnation.

EP1353006 A1 discloses a process for producing porous non-woven suede leather. It is mentioned that the selected aqueous polyurethane dispersion should satisfy the requirements of the production steps, such as the conditions for removing sea components, the conditions for resisting high-temperature, acid and alkali under dyeing conditions, and the crosslinking agent can be selected to improve the physical and mechanical properties, solvent resistance and durability of the aqueous polyurethane dispersion. The candidate crosslinking agent includes melamine, aziridine, a carbodiimide, an epoxide, a zirconium compound, an isocyanate or a blocked isocyanate.

WO2019025964 A1 discloses a process for producing porous non-woven suede leather using an aqueous polyurethane dispersion, which may use 0.5-10% of a cross-linking agent, the candidate cross-linking agent includes melamine, aziridine, a carbodiimide, an epoxide, a zirconium compound or an isocyanate; preferably a carbodiimide and a low temperature deblocking isocyanate crosslinking agent, because they remain stable for a longer period of time and the production is more manageable.

JP2011042896 A1 discloses an aqueous polyurethane dispersion containing a carboxyl group or a carboxylate salt group, and a process for impregnating a fibrous fabric material with this polyurethane. The process does not use a crosslinking agent.

### SUMMARY OF THE INVENTION

The term “polyurethane” means polyurethane urea and/or polyurethane polyurea and/or polyurea and/or polythiourethane.

The aqueous polyurethane dispersion of the present invention may be directly added as dispersion to the composition, or may be added in form of a polyurethane polymer and water to the composition and mixed to form a dispersion.

The term “impregnation” means that liquid permeates into a flexible absorbent body, and the flexible absorbent body may be an absorbent body made of polyvinyl chloride, polyvinylidene chloride, nylon, polypropylene, polyester, cellulose, polyacrylamide, polyurethane, or the like.

The object of the present invention is to provide an acid-resistant and alkali-resistant composition, a preparation process thereof and use thereof in producing an article, and an article comprising a substrate coated or impregnated with the same and the preparation method and use of the article.

The composition according to the present invention contains:
at least one aqueous polyurethane dispersion having a carboxyl group;
at least one crosslinking agent having an isocyanate reactive group;
at least one crosslinking agent having a carboxyl reactive group; and
optionally an additive;
wherein, the amount of the carboxyl groups in said aqueous polyurethane dispersion is more than 0.05 wt %, based on the amount of said aqueous polyurethane dispersion being 100 wt %; the amount of said crosslinking agent having an isocyanate reactive group is 0.2 wt %-10 wt %, based on the amount of said composition being 100 wt %; the molar ratio of the carboxyl reactive groups to the carboxyl groups of said composition is more than 0.5.

According to an aspect of the present invention, there is provided a process for preparing the composition provided according to the present invention, which comprises the following steps: mixing said aqueous polyurethane dispersion having a carboxyl group, said crosslinking agent having an isocyanate reactive group, said crosslinking agent having a carboxyl reactive group and optionally said additive in any manner.

According to an aspect of the present invention, there is provided use of the composition provided according to the present invention in producing an article.

According to an aspect of the present invention, there is provided an article comprising a substrate coated or impregnated with the composition provided according to the present invention.

According to an aspect of the present invention, there is provided use of the article provided according to the present invention in the field of automotive, decoration, clothing, shoes and consumer-electronics.

According to an aspect of the present invention, there is provided a process for producing an article, which comprises the following steps:
i) impregnating sea-island type bicomponent superfine fibers into the composition provided according to the present invention;
ii) taking out and drying the sea-island type bicomponent superfine fibers treated in step i), and then impregnating the sea-island type bicomponent superfine fibers into hot alkali or hot water to remove the sea component in fibers to obtain superfine fibers; and
iii) taking out and drying the superfine fibers to obtain said article.

According to an aspect of the present invention, there is provided a process for producing an article, which comprises the following steps:
a) impregnating sea-island type bicomponent superfine fibers into hot alkali or hot water to remove the sea component in fibers to obtain superfine fibers;
b) taking out and drying the superfine fibers treated in step a), and then impregnating the superfine fibers into the composition provided according to the present invention; and
c) taking out and drying the superfine fibers to obtain said article.

The film formed with the composition of the present invention has good acid-resistance and alkali-resistance, particularly hot alkali-resistance and hot acid-resistance. The product obtained by treating with the composition of the present invention has flat appearance and good handfed, and therefore the composition of the present invention is particularly suitable for the harsh conditions of the superfine fiber impregnation process: the thermal alkali condition of the fiber opening process and the thermal acid condition of the dyeing process (pH<6).

### DETAILED DESCRIPTION OF THE INVENTION

The composition provided by the present invention contains at least one aqueous polyurethane dispersion having a carboxyl group; at least one crosslinking agent having an isocyanate reactive group; at least one crosslinking agent having a carboxyl reactive group; and optionally an additive; wherein, the amount of the carboxyl groups in said aqueous polyurethane dispersion is more than 0.05 wt %, based on the amount of said aqueous polyurethane dispersion being 100 wt %; the amount of said crosslinking agent having an isocyanate reactive group is 0.2 wt %-10 wt %, based on the amount of said composition being 100 wt %; the molar ratio of the carboxyl reactive groups to the carboxyl groups of said composition is more than 0.5. The present invention further provides a process for preparing the composition, use thereof in producing an article, and an article comprising a substrate coated or impregnated with the same and the preparation method and use of the article.

### Aqueous Polyurethane Dispersion Having a Carboxyl Group

The amount of said aqueous polyurethane dispersion having a carboxyl group is 80 wt %-98 wt %, based on the amount of said composition being 100 wt %.

The amount of the carboxyl group of said aqueous polyurethane dispersion is preferably more than 0.05 wt % and less than equal to lwt %, further preferably 0.1 wt %-0.5 wt %, based on the amount of said aqueous polyurethane dispersion being 100 wt %.

The pH of said aqueous polyurethane dispersion is preferably less than 8.0, further preferably less than 7.5, most preferably 6.5-7.5.

The solid content of said aqueous polyurethane dispersion is preferably 30 wt %-55 wt %, based on the amount of said aqueous polyurethane dispersion being 100 wt %.

The viscosity of said aqueous polyurethane dispersion is preferably 15 mPa·s-4000 mPa·s.

The particle size of said aqueous polyurethane dispersion is preferably 50 nm-7000 nm, most preferably 150 nm-7000 nm.

Said aqueous polyurethane dispersion preferably contains a polyurethane obtained by the reaction of a system comprising an isocyanate and a polymer polyol, said polymer polyol is one or more of the following: polyether polyol and polycarbonate polyol.

When said polymer polyol is a polycarbonate polyol, said aqueous polyurethane dispersion is preferably an aqueous anionic aliphatic polycarbonate polyurethane dispersion.

When said polymer polyol is a polyether polyol, said aqueous polyurethane dispersion preferably contains a polyurethane obtained by the reaction of a system comprising the following components:
A1) at least one polyisocyanate having an isocyanate functionality of not less than 2;
A2) at least two different polytetramethylene ether glycols A2a) and A2b), said A2a) has a number average molecular weight of not more than 1500 g/mol, said A2b) has a number average molecular weight of more than 1500 g/mol; and
A3) at least one anionic or potentially anionic hydrophilic agent having a number average molecular weight of 32 g/mol-400 g/mol and having hydroxyl and carboxyl groups;
B) at least one anionic or potentially anionic hydrophilic agent having an amino functionality;
C) at least one amino functional compound having no hydrophilic group and having a number-average molecular weight of 32 g/mol-400 g/mol; and
D) optionally a neutralizer;
wherein the ratio of the number average molecular weight of said A2a) to the number average molecular weight of said A2b) is 1:9-4:1, the weight of said A3) anionic or potentially anionic hydrophilic agent having a number average molecular weight of 32 g/mol-400 g/mol and having hydroxyl and carboxyl groups is 20%-70% of the weight of the hydrophilic agent of said system.

### A1) Polyisocyanate

Said polyisocyanate has an isocyanate functionality of preferably 2-4, further preferably 2-2.6, still preferably 2-2. 4, most preferably 2.

Said polyisocyanate is preferably one or more of the following: aliphatic polyisocyanate and cycloaliphatic polyisocyanate, further preferably one or more of the following: 1,4-butylene diisocyanate, hexamethylene diisocyanate (HDI), isophorone diisocyanate (IPDI), 2,2,4- and/or 2,4,4-trimethyl-hexamethylene diisocyanate, the isomeric bis(4,4′-isocyanatocyclohexyl)methanes, 1,4-cyclohexylene diisocyanate, 1,4-phenylene diisocyanate, 2,4-toluene diisocyanate, 2,6-toluene diisocyanate, 1,5-naphthylene diisocyanate, 2,2′-diphenylmethane diisocyanate, 2,4′-diphenylmethane diisocyanate, 4,4′-diphenylmethane diisocyanate, 1,3-bis(2-isocyanatoprop-2-yl)benzene (TMXDI), 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) with C1-C8 alkyl groups and derivatives thereof having a uretdione, isocyanurate, urethane, allophanate, biuret, iminooxadiazinedione and/or oxadiazine-trione structure; most preferably one or more of the following: hexamethylene diisocyanate and isophorone diisocyanate.

The amount of said polyisocyanate is preferably 5 wt %-40 wt %, further preferably 5 wt %-35 wt %, most preferably 10 wt %-30 wt %, based on the amount of the system being 100 wt %.

### Polytetramethylene Ether Glycols A2a) and A2b)

The polytetramethylene ether glycols A2a) and A2b) of the present invention each independently correspond to the general formula: (HO—(CH₂—CH₂—CH₂—CH₂—O)ₓ—H).

Said polytetramethylene ether glycol (polytetramethylene glycol polyether) can be, for example, obtained by the cationic ring-opening polymerization of tetrahydrofuran.

Said polytetramethylene ether glycol A2a) has a number average molecular weight of preferably 400 g/mol-1500 g/mol, further preferably 600 g/mol-1200 g/mol, most preferably 1000 g/mol.

Said polytetramethylene ether glycol A2b) has a number average molecular weight of preferably more than 1500 g/mol and less than equal to 8000 g/mol, further preferably 1800 g/mol-4000 g/mol, most preferably 2000 g/mol.

The ratio of the number average molecular weight of said polytetramethylene ether glycol A2a) to the number average molecular weight of said polytetramethylene ether glycol A2b) is preferably 1:4-7:3, most preferably 1:4-1:1.

The number average molecular weight is determined by gel permeation chromatography in tetrahydrofuran at 23° C. against polystyrene standards.

The mass ratio of said polytetramethylene ether glycol A2a) to said polytetramethylene ether glycol A2b) is preferably 1:15-2:1, most preferably 1:10-1:1.

The amount of said A2) polytetramethylene ether glycol is preferably 55 wt %-90 wt %, further preferably 60 wt %-90 wt %, most preferably 65 wt %-85 wt %, based on the amount of the system being 100 wt %.

A3) Anionic or Potentially Anionic Hydrophilic Agent Having a Number Average Molecular Weight of 32 g/Mol-400 g/Mol and Having Hydroxyl and Carboxyl Groups

Said A3) is preferably dimethylolpropionic acid.

The weight of said A3) anionic or potentially anionic hydrophilic agent having a number average molecular weight of 32 g/mol-400 g/mol and having hydroxyl and carboxyl groups is preferably 20%-60%, further preferably 20%-35%, most preferably 20%-30% of the weight of the hydrophilic agent of said system.

### A4) Other Polymer Polyol

Said system can further contain a polymer polyol other than A2) said polytetramethylene polyether glycol.

Said polymer polyol is preferably one or more of the following: polyester polyol, polyacrylate polyol, polyurethane polyol, polycarbonate polyol, polyether polyol, polyester polyacrylate polyol, polyurethane polyacrylate polyol, polyurethane polyester polyol, polyurethane polyether polyol, polyurethane polycarbonate polyol and polyester polycarbonate polyol.

The content of said polymer polyol is preferably 0-20 wt %, further preferably 0-10 wt %, most preferably 0-5 wt %, based on said A2).

A5) Hydroxyl-Functional Compound Having a Number Average Molecular Weight of 62-399 g/mol

Said system may further contain a hydroxyl-functional compound having a number average molecular weight of 62-399 g/mol.

Said hydroxyl-functional compound having a number average molecular weight of 62-399 g/mol is preferably one or more of the following: non-polymer polyol having up to 20 carbon atoms, ester diol and mono-functional isocyanate-reactive hydroxyl-containing compound.

Said non-polymer polyol having up to 20 carbon atoms is preferably one or more of the following: ethylene glycol, diethylene glycol, triethylene glycol, 1,2-propylene glycol, 1,3-propylene glycol, 1,4-butanediol, 1,3-butanediol, cyclohexanediol, 1,4-cyclohexanedimethanol, 1,6-hexanediol, neopentyl glycol, hydroquinone dihydroxylethyl ether, bisphenol A (2,2-bis(4-hydroxylphenyl)propane), hydrogenated bisphenol A (2,2-bis(4-hydroxylcyclohexyl)propane), trimethylolpropane, trimethylolethane, glycerol, and pentaerythritol.

Said ester diol is preferably one or more of the following: α-hydroxylbutyl-ε-hydroxyl hexanoate, ω-hydroxylhexyl-γ-hydroxyl butyrate, (β-hydroxylethyl) adipate and di(β-hydroxylethyl) terephthalate.

Said mono-functional isocyanate-reactive hydroxyl-containing compound is preferably one or more of the following: ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, tripropylene glycol monopropyl ether, propylene glycol monobutyl ether, dipropylene glycol monobutyl ether, tripropylene glycol monobutyl ether, 2-ethylhexanol, 1-octanol, 1-dodecanol and 1-hexadecanol.

The amount of said hydroxyl-functional compound having a number average molecular weight of 62-399 g/mol is preferably 0-10 wt %, most preferably 0-5 wt %, based on the solid weight of said aqueous polyurethane dispersion being 100 wt %.

### A6) Isocyanate Reactive Nonionic Hydrophilic Agent

Said system can further contain an isocyanate reactive nonionic hydrophilic agent.

Said isocyanate reactive nonionic hydrophilic agent is preferably one or more of the following: polyoxyalkylene ether having a hydroxyl group, polyoxyalkylene ether having an amino group and polyoxyalkylene ether having a thiol group.

Said isocyanate reactive nonionic hydrophilic agent is most preferably a polyalkylene oxide polyether alcohol having a monohydroxyl functionality, which has a statistical average number of ethylene oxide units per molecule of preferably 5-70, particularly preferably 7-55. This compound can be obtained in a known manner by alkoxylation of a suitable starting molecule (for example, Ullmanns Encyclopadie der technischen Chemie, 4th edition, vol. 19, Verlag Chemie, Weinheim pp. 31-38). Said polyalkylene oxide polyether alcohol having a monohydroxyl functionality preferably has 40-100 mol % of ethylene oxide units and 0-60 mol % of propylene oxide units.

Said starting molecule is preferably saturated monoalcohol, diethylene glycol monoalkyl ether, unsaturated alcohol, aromatic alcohol, araliphatic alcohol, secondary monoamine and heterocyclic secondary amine, most preferably saturated monoalcohol.

Said saturated monoalcohol is preferably one or more of the following: methanol, ethanol, n-propanol, iso-propanol, n-butanol, iso-butanol, sec-butanol, isomeric pentanols, hexanol, octanol, nonanol, n-decanol, n-dodecanol, n-tetradecanol, n-hexadecanol, n-octadecanol, cyclohexanol, isomeric methylcyclohexanols, hydroxylmethylcyclohexane, 3-ethyl-3-hydroxylmethyloxetane, tetrahydrofurfuryl alcohol and diethylene glycol monoalkyl ether, most preferably one or more of the following: n-butanol and diethylene glycol monobutyl ether.

Said unsaturated alcohol is preferably one or more of the following: allyl alcohol, 1,1-dimethylallyl alcohol and oleyl alcohol.

Said aromatic alcohol is preferably one or more of the following: phenol, isomeric cresols and methoxyphenol.

Said araliphatic alcohol is preferably one or more of the following: benzyl alcohol, anisyl alcohol and cinnamyl alcohol.

Said secondary monoamine is preferably one or more of the following: dimethylamine, diethylamine, dipropylamine, diisopropylamine, dibutylamine, bis(2-ethylhexyl)amine, N-methylcyclohexylamine, N-ethylcyclohexylamine and dicyclohexylamine.

Said heterocyclic secondary amine is preferably one or more of the following: morpholine, pyrrolidine, piperidine and 1H-pyrazole.

The composition of the present invention may contain one aqueous polyurethane dispersion satisfying the requirements of the present invention, also may contain two or more aqueous polyurethane dispersions satisfying the requirements of the present invention.

### B) Anionic or Potentially Anionic Hydrophilic Agent Having an Amino Functionality

Said B) anionic or potentially anionic hydrophilic agent having an amino functionality preferably contains one or more of the following groups: sulfonic acid group, sulfonate salt group, carboxylic acid group, and carboxylate ester group, most preferably sulfonate salt group. Said sulfonate salt group is preferably a sodium sulfonate group.

Said B) anionic or potentially anionic hydrophilic agent having an amino functionality is preferably one or more of the following: alkali metal salt of monoamine sulfonic acid, alkali metal salt of diaminesulfonic acid, diamino carboxylic acid and diamino carboxylate salt; further preferably one or more of the following: a compound containing a sulfonate salt group as ionic group and two amino groups, a compound containing a carboxylic acid group as ionic group and two amino groups, and a compound containing a carboxylate salt group as ionic group and two amino groups; still preferably one or more of the following: 2-(2-aminoethylamino)ethanesulfonate salt, 1,3-propanediamine-β-ethanesulfonate salt, diamino carboxylate salt and 2,6-diamino carboxylic acid; still further preferably one or more of the following: 2-(2-aminoethylamino)ethanesulfonate salt, ethylene diaminepropylsulfonate salt, ethylene diaminebutylsulfonate salt, 1,2-propanediamine-β-ethanesulfonate salt, 1,2-propanediamine-β-taurate salt, 1,3-propanediamine-β-ethanesulfonate salt, 1,3-propanediamine-β-taurate salt, cyclohexylaminopropanesulfonate salt (CAPS), sodium diamino carboxylate and 2,6-diamino hexanoic acid; most preferably sodium 2-[(2-aminoethyl)amino]ethanesulfonate.

C) Amino Functional Compound Having No Hydrophilic Group and Having a Number-Average Molecular Weight of 32 g/Mol-400 g/Mol

Said amino functional compound having no hydrophilic group and having a number-average molecular weight of 32 g/mol-400 g/mol is preferably an amine without ionic group or ionized group.

Said amine without ionic group or ionized group is preferably one or more of the following: organic diamine, organic polyamine, primary secondary amine, alkanolamine and monofunctional isocyanate reactive amine compounds.

Said organic diamine or organic polyamine is preferably one or more of the following: 1,2-ethylene diamine, 1,2-diaminopropane, 1,3-diaminopropane, 1,4-diaminobutane, 1,6-diaminohexane, isophorone diamine, 2,2,4-trimethyl-hexamethylene diamine, 2,4,4-trimethyl-hexamethylene diamine, 2-methylpentamethylene diamine, diethylene triamine, 4,4-diaminodicyclohexylmethane, hydrated hydrazine and dimethylethylene diamine.

Said primary secondary amine is preferably one or more of the following: diethanolamine, 3-amino-1-methylaminopropane, 3-amino-1-ethylaminopropane, 3-amino-1-cyclohexylaminopropane and 3-amino-1-methylaminobutane.

Said alkanolamine is preferably one or more of the following: N-aminoethylethanolamine, ethanolamine, 3-aminopropanol and neopentanolamine.

Said monofunctional isocyanate reactive amine compound is preferably one or more of the following: methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl (methyl)aminopropylamine, morpholine, piperidine and suitable substituted derivatives thereof such as an amido-amine formed from diprimary amine and monocarboxylic acid, and an monoketo-imide of diprimary amine and primary/tertiary amine.

Said amine without ionic group or ionized group is most preferably one or more of the following: 1,2-ethylene diamine, di(4-aminocyclohexyl)methane, 1,4-diaminobutane, isophorone diamine, ethanolamine, diethanolamine and diethylene triamine.

The weight sum of said A5) and said C) is preferably 0.5 wt %-20 wt %, further preferably 0.5 wt %-15 wt %, most preferably 0.5 wt %-14 wt %, based on the amount of the system being 100 wt %.

The weight sum of said A6) and said B) is preferably 0.1 wt %-25 wt %, further preferably 0.1 wt %-15 wt %, most preferably 0.1 wt %-13.5 wt %, based on the amount of the system being 100 wt %.

### D) Neutralizer

The molar amount of said neutralizer is preferably less than equal to 50 mol %, most preferably less than equal to 30 mol %, based on the molar amount of said A3) anionic or potentially anionic hydrophilic agent having a number average molecular weight of 32 g/mol-400 g/mol and having hydroxyl and carboxyl groups being 100 mol %.

Said neutralizer is preferably one or more of the following ammonia, ammonium carbonate, ammonium bicarbonate, trimethylamine, triethylamine, tributylamine, diisopropylethylamine, dimethylethanolamine, diethylethanolamine, triethanolamine, lithium hydroxide, sodium hydroxide, potassium hydroxide, dimethyl ether sulfate, succinic acid and sodium carbonate, most preferably one or more of the following: triethylamine, triethanolamine, dimethylethanolamine, sodium hydroxide, potassium hydroxide, diisopropylethylamine, dimethyl ether sulfate and succinic acid.

### Crosslinking Agent Having an Isocyanate Reactive Group

The amount of said crosslinking agent having an isocyanate reactive group is preferably 0.5 wt %-10 wt %, most preferably 2 wt %-6 wt %, based on the amount of said composition being 100 wt %.

Said crosslinking agent having an isocyanate reactive group is preferably a hydrophilically modified aliphatic isocyanate crosslinking agent.

Said hydrophilically modified aliphatic isocyanate crosslinking agent is preferably blocked and/or unblocked.

The isocyanate group content of said hydrophilically modified aliphatic isocyanate crosslinking agent is preferably 10 wt %-20 wt %, based on the amount of said hydrophilically modified aliphatic isocyanate crosslinking agent being 100 wt %.

The viscosity of said hydrophilically modified aliphatic isocyanate crosslinking agent is preferably not more than 8000 mPa·s.

### Crosslinking Agent Having a Carboxyl Reactive Group

The amount of the active ingredient of said crosslinking agent having a carboxyl reactive group is preferably 0.5 wt %-10 wt %, based on the amount of said composition being 100 wt %.

Said crosslinking agent having a carboxyl reactive group is preferably a hydrophilically modified carbodiimide.

The NCO group content of said hydrophilically modified carbodiimide is preferably 3 wt %-5 wt %, based on the amount of said hydrophilically modified carbodiimide being 100 wt %.

The molar ratio of the carboxyl reactive groups to the carboxyl groups of said composition is preferably more than 0.5 and less than equal to 2, most preferably 0.75-2.

### Additive

Said additive can be one or more of the following: defoamer, thickener, thixotropic agent, antioxidant, light stabilizer, emulsifier, plasticizer, pigment, filler, additives for skein stabilizing, biocide, pH regulator and flow control agent.

The amount of the additive may be an amount well known to those skilled in the art.

### Process

The process for preparing said aqueous polyurethane dispersion preferably comprises the following steps:
I) mixing and reacting A1) at least one polyisocyanate having an isocyanate functionality of not less than 2; A2) at least two different polytetramethylene ether glycols A2a) and A2b), said A2a) has a number average molecular weight of not more than 1500 g/mol, said A2b) has a number average molecular weight of more than 1500 g/mol; and A3) at least one anionic or potentially anionic hydrophilic agent having a number average molecular weight of 32 g/mol-400 g/mol and having hydroxyl and carboxyl groups to obtain an isocyanate functional pre-polymer;
II) reacting said isocyanate functional pre-polymer, B) at least one anionic or potentially anionic hydrophilic agent having an amino functionality, C) at least one amino functional compound having no hydrophilic group and having a number-average molecular weight of 32 g/mol-400 g/mol and D) optionally a neutralizer to produce a polyurethane; and
III) introducing water before, during or after step II) to produce said aqueous polyurethane dispersion;
wherein the ratio of the number average molecular weight of said A2a) to the number average molecular weight of said A2b) is 1:9-4:1, the weight of said A3) anionic or potentially anionic hydrophilic agent having a number average molecular weight of 32 g/mol-400 g/mol and having hydroxyl and carboxyl groups is 20%-70% of the weight of the hydrophilic agent of said system.

The process for preparing said aqueous polyurethane dispersion preferably comprises the following steps:
I) mixing and reacting A1) at least one polyisocyanate having an isocyanate functionality of not less than 2; A2) at least two different polytetramethylene ether glycols A2a) and A2b), said A2a) has a number average molecular weight of not more than 1500 g/mol, said A2b) has a number average molecular weight of more than 1500 g/mol; A3) at least one anionic or potentially anionic hydrophilic agent having a number average molecular weight of 32 g/mol-400 g/mol and having hydroxyl and carboxyl functionalities; A4) optionally other polymer polyol; A5) optionally, a hydroxyl-functional compound having a number average molecular weight of 62-399 g/mol; and A6) optionally an isocyanate reactive nonionic hydrophilic agent to obtain an isocyanate functional pre-polymer;
II) reacting said isocyanate functional pre-polymer, B) at least one anionic or potentially anionic hydrophilic agent having an amino functionality, C) at least one amino functional compound having no hydrophilic group and having a number-average molecular weight of 32 g/mol-400 g/mol and D) optionally a neutralizer to produce a polyurethane; and
III) introducing water before, during or after step II) to obtain said aqueous polyurethane dispersion;
wherein the ratio of the number average molecular weight of said A2a) to the number average molecular weight of said A2b) is 1:9-4:1, the weight of said A3) anionic or potentially anionic hydrophilic agent having a number average molecular weight of 32 g/mol-400 g/mol and having hydroxyl and carboxyl groups is 20%-70% of the weight of the hydrophilic agent of said system.

The preparation of said aqueous polyurethane dispersion can be carried out in one or more steps in a homogeneous phase, or carried out in a multi-step reaction, partly in a dispersed phase. After the polyaddition reaction of A1) to A6) has been completely or partially completed, a dispersing, emulsifying or dissolving step is preferably carried out. Optionally, a further polyaddition or modification reaction in the dispersed phase is subsequently carried out.

Said aqueous polyurethane dispersion can be prepared using all methods known in the art, such as the pre-polymer mixing method, the acetone method or the melt-dispersion method, most preferably using the acetone method.

For the preparation in the acetone method, in order to prepare the isocyanate functional pre-polymer, in general, firstly components A1)-A6) are completely or partially added and optionally diluted with a water-miscible solvent but inert to isocyanate groups and heated to a temperature in the range from 50° C. to 120° C. To accelerate the isocyanate addition reaction, catalysts known in the polyurethane chemistry can be used.

Suitable solvents are conventional aliphatic keto-functional solvents, such as acetone or 2-butanone, which can be added not only at the beginning of the preparation but also optionally partially added afterwards. Other solvents without isocyanate-reactive groups may also be added.

The components of A1) to A6) which have not been added are optionally metered in at the beginning of the reaction.

In the preparation of the isocyanate functional pre-polymer of said step I), the molar ratio of isocyanate group to isocyanate reactive group is preferably 1.05-3.5, further preferably 1.1-3.0, most preferably 1.1-2.5.

The reaction of the components A1) to A6) carried out for the formation of the pre-polymer in said step I) can partially or completely take place, but preferably completely take place. In this way, isocyanate-functional polyurethane pre-polymers containing free isocyanate groups are obtained in bulk per se or in solution. “Free” in the present invention includes free and potentially free.

If the water for dispersion already contains said neutralizer, the neutralization reaction can also take place simultaneously with the dispersion.

In the subsequent processing steps, if the dissolution of the isocyanate-functional pre-polymer has not taken place or has only partially taken place, the obtained pre-polymer is dissolved with the aid of aliphatic ketones, such as acetone or 2-butanone.

Said step II) is a chain extension and termination reaction, and said B) at least one anionic or potentially anionic hydrophilic agent having an amino functionality, C) at least one amino functional compound having no hydrophilic group and having a number-average molecular weight of 32 g/mol-400 g/mol, and D) optionally a neutralizer are reacted with the free isocyanate group of the isocyanate-functional pre-polymer obtained in said step I.

The degree of the chain extension reaction of said step II), i.e., the equivalent ratio of the isocyanate-reactive group of the compound used for the chain extension and termination reaction to the free isocyanate group is preferably 40%-150%, further preferably 50%-110%, most preferably 60%-100%.

The components B) and C) of said step II) can optionally be used in water- or solvent-diluted form, individually or in mixtures, and the order of addition can be any order possible in principle. If water or an organic solvent is used as diluent, the amount of diluent is 40 wt %-95 wt % of the amount of the component used for the chain extension in said step II).

Said step II) is preferably carried out before the dispersion with water. For this purpose, the dissolved and chain-extended pre-polymer, optionally with application of strong shear, such as vigorous stirring, can be added to the water, or conversely, water can be added with stirring to the dissolved and chain-extended polyurethane polymer. Water is preferably added to the polyurethane polymer which has been dissolved and chain-extended.

The solvent still contained in the dispersion is generally removed by distillation. The solvent may also be removed during the dispersing step.

The residual content of the organic solvent in the aqueous polyurethane dispersion prepared by the process of the present invention is preferably 0-10 wt %, most preferably 0-3 wt %, based on the amount of said aqueous polyurethane dispersion being 100 wt %.

### Substrate

Said substrate is preferably a superfine fiber, most preferably one or more of the following: superfine fiber nonwoven fabric and superfine fiber.

Said article comprises a film formed by curing said composition on said substrate.

Said film has a weight/volume ratio of preferably more than 80.

### A Process for Producing an Article

Preferably, a step iv) of taking out and drying the superfine fiber treated in the step ii), and then impregnating the superfine fiber in a dye is further concluded between said step ii) and said step iii).

Preferably, a step d) of taking out and drying the superfine fiber treated in the step b), and then impregnating the superfine fiber in a dye is further concluded between said step b) and said step c).

Said fiber is preferably cleaned prior to drying.

Said impregnation can be that the fiber is partially or completely placed in said composition, most preferably the fiber is completely placed in said composition.

The sea component and the island component of said sea-island type bicomponent superfine fiber are different.

The island component of said sea-island type bicomponent superfine fiber can be a conventional polymer in the textile application, and is preferably one or more of the following: ethylene terephthalate, modified polyesters such as poly(trimethylene terephthalate), cationic polyesters, nylon, other types of polyamides, polyethylene, polypropylene, and other types of polyolefins. The sea component of said sea-island type bicomponent superfine fiber can be a polymer that can be dissolved and removed with a treatment means such as water, an aqueous alkali solution or an aqueous acid solution, and is preferably one or more of the following:

nylons, other polyamides, modified polyesters, and other spinnable polymers having the basic properties such as solubility in water, an aqueous acid solution or an aqueous alkali solution, most preferably one or more of the following: alkali water-soluble polyester (CO-PET) and hot water-soluble polyvinyl alcohol (PVA).

Said article is preferably suitable for use in surfaces and structures in the automotive interior, decorations (walls, sofas, armchairs, carpets), handbags, suitcases, coverings, boxes, musical instruments and electronic devices. The above list is merely provided as examples, and is not intended to be an exhaustive list.

### DESCRIPTION OF THE DRAWINGS

The invention will be described and explained with additional specificity and detail through the use of the accompanying drawings in which:

FIG. 1 is an external view of a superfine fiber nonwoven fabric sample obtained by the impregnation with the composition of Example 6, wherein the superfine fiber nonwoven fabric sample has a flat appearance and few wrinkles.

FIG. 2 is an external view of a superfine fiber nonwoven fabric sample obtained by the impregnation with the comparative composition of Comparative Example 12, wherein the superfine fiber nonwoven fabric sample has an uneven appearance and many wrinkles.

### EXAMPLES

Unless defined otherwise, all technical and scientific terms used herein have the same meaning as commonly understood by one of ordinary skill in the art to which this invention belongs. When a definition of a term in the specification contradicts a meaning commonly understood by a person skilled in the art to which the present invention belongs, the definition described herein dominates.

Unless otherwise indicated, all numbers expressing the ingredient amount, the reaction condition and the like used in the specification and claims are to be understood as being modified with the term “about”. Accordingly, unless indicated to the contrary, the numerical parameters set forth herein are approximations that may vary depending upon the desired properties that need to be obtained.

The expression “and/or” as used herein refers to one or all of the mentioned elements.

As used herein, the expressions “ . . . or more” and “ . . . or less” include the recited values themselves, unless otherwise indicated.

As used herein, the terms “comprising” and “containing” encompass the situation where only the mentioned element is present as well as the situation where there are other unrecited elements in addition to the mentioned element.

The analytical measurement in the present invention is carried out at 23° C., unless otherwise stated.

The percentage used in the present invention is by weight, unless otherwise indicated.

The solid content of the aqueous polyurethane dispersion is determined using a HS153 moisture meter from the Mettler Toledo company in accordance with DIN-EN ISO 3251.

The number average molecular weight is determined with the gel permeation chromatography in tetrahydrofuran at 23° C. against the polystyrene standard.

The hydroxyl number is determined in accordance with ASTM D4274.

The isocyanate group (NCO) content is determined by volume in accordance with DIN-EN ISO 11909, and the determined data include the free and potentially free NCO contents.

The functionality of the isocyanate group is determined in accordance with GPC.

The particle size of the aqueous polyurethane dispersion is determined after dilution with deionized water using the laser spectroscopy (measured with the Zatasizer Nano ZS 3600 laser particle sizer from the Malvern instrument company).

The viscosity is measured at 23° C. in accordance with DIN 53019 using the DV-II+Pro. rotational viscometer from the Brookfield company.

The pH value of the aqueous polyurethane dispersion is measured at 23° C. using a PB-10 pH meter from the Sartorius company (Germany).

### Raw Materials and Reagents

Impranil® 1701: an aqueous anionic aliphatic polycarbonate polyurethane dispersion, having a solid content of 40 wt %, and based on a polycarbonate polyol, a carboxylic acid group of 0.3 wt %, commercially available from Covestro Co., Ltd.

Impranil® DLU: an aqueous anionic/nonionic aliphatic polycarbonate-polyether polyurethane dispersion, having a solid content of 60 wt %, free of carboxyl group, based on the combined polyol of polyether polyol and polycarbonate polyol, commercially available from Covestro Co., Ltd.

Imprafix® 2794: a hydrophilically modified blocked aliphatic isocyanate crosslinking agent, having a solid content of 38 wt %, an isocyanate group (NCO) content of 12.7 wt % (based on the solid content), and a viscosity of <1500 mPa·s, commercially available from Covestro Co., Ltd.

Imprafix® 3025: a hydrophilically modified unblocked aliphatic isocyanate crosslinking agent, having a solid content of 100 wt %, an isocyanate group content of 16.2 wt %, and a viscosity of 6500±1500 mPa·s, commercially available from Covestro Co., Ltd.

Desmodur® 2802: a hydrophilically modified carbodiimide crosslinking agent, having a solid content of 40 wt %, and an NCN group content of 4.2 wt %, commercially available from Covestro Co., Ltd.

Desmodur®H: 1,6-hexamethylene diisocyanate, commercially available from Covestro Co., Ltd. (Germany).

Desmodur®I: isophorone diisocyanate, commercially available from Covestro Co., Ltd. (Germany).

polytetramethylene ether glycol 1000: having a hydroxyl number of 112 mg KOH/g, a hydroxyl functionality of 2, and a number-average molecular weight of 1000 g/mol, commercially available from BASF Corp. (Germany).

Polytetramethylene ether glycol 2000: having a hydroxyl number of 56 mg KOH/g, a hydroxyl functionality of 2, and a number-average molecular weight of 2000 g/mol, commercially available from BASF Corp. (Germany).

Dimethylolpropionic acid, commercially available from Aldrich Chemical Co. Inc. (Germany).

Sodium 2-[(2-aminoethyl)amino]ethanesulfonate solution: NH₂—CH₂CH₂—NH—CH₂CH₂—SO₃Na, having a concentration of 45% in water, commercially available from Covestro Co., Ltd. (Germany).

Ethylene diamine, commercially available from Jiaxing Jinyan chemical Co., Ltd., China.

Sodium hydroxide: analytically pure, commercially available from Sinopharm Chemical Reagent Co. Ltd.

Acetic acid: analytically pure, commercially available from Kelin Reagent Co. Ltd.

Borchi Gel®ALA: a polyacrylic acid-type thickener, having a non-volatile component's content of 9 wt %-11 wt %, commercially available from Borchers GmbH.

LYOPRINT®PTF: a polyacrylic acid-type thickener, having an active ingredient content of <60 wt %, commercially available from Xianhua (Shanghai) Bio Chemical Co., Ltd.

BYK® 333: polyether modified silicone, available from BYK Additives & Instruments.

Superfine fiber nonwoven fabric, commercially available.

### Preparation of the Aqueous Polyurethane Dispersion A

1015 g of polytetramethylene ether glycol 2000, 217.5 g of polytetramethylene ether glycol 1000, 15.6 g of dimethylolpropionic acid, 144.4 g of Desmodur®I and 109.3 g of Desmodur®H were mixed at 70° C., heated to 110° C. and stirred at this temperature until the actual value of the isocyanate groups (NCO) of the pre-polymer was the theoretical value of NCO or less. The pre-polymer was dissolved in 2669.7 g of acetone at 90° C., stirred for 20 minutes and then cooled to 40° C. Then, 12.4 g of ethylene diamine, 50.2 g of a sodium 2-[(2-aminoethyl)amino] ethanesulfonate solution and 310.1 g of water were metered in, and stirred for 20 minutes. Then 1967.3 g of water was added for dispersion, and the solvent was removed by the distillation in vaccum to obtain an aqueous polyurethane aqueous dispersion A, having a solid content of 41.8 wt %, a viscosity of 159 mPa·s (23° C.), a pH of 6.7, a carboxyl group content of 0.13 wt % and a particle size of 163.5 nm.

### The Compositions of Examples 1-5 and Comparative Examples 1-11

Table 1 lists the components of the compositions of Examples 1-5 and Comparative Examples 1-11.

TABLE 1
Components of the compositions of Examples and Comparative Examples

| | Molar ratio of | | | |
|---|---|---|---|---|
| | carboxyl | Components of the composition | | |
| | reactive group | | Crosslinking | Crosslinking |
| Example/ | to carboxyl | Aqueous | agent having an | agent having a |
| Comparative | group of the | polyurethane | isocyanate | carboxyl reactive |
| Example | composition | dispersion | reactive group | group |
| Example 1 | 1 | 100 parts of | 5 parts of | 3 parts of |
| | | aqueous | Imprafix ®2794 | Desmodur ®2802 |
| | | polyurethane | | |
| | | dispersion A | | |
| Example 2 | 1 | 100 parts of | 3 parts of | 3 parts of |
| | | aqueous | Imprafix ®2794 | Desmodur ®2802 |
| | | polyurethane | | |
| | | dispersion A | | |
| Example 3 | 2 | 100 parts of | 5 parts of | 6 parts of |
| | | aqueous | Imprafix ®2794 | Desmodur ®2802 |
| | | polyurethane | | |
| | | dispersion A | | |
| Comparative | 0.5 | 100 parts of | 5 parts of | 1.5 parts of |
| Example 1 | | aqueous | Imprafix ®2794 | Desmodur ®2802 |
| | | polyurethane | | |
| | | dispersion A | | |
| Comparative | 0 | 100 parts of | 3 parts of | |
| Example 2 | | aqueous | Imprafix ®3025 | |
| | | polyurethane | | |
| | | dispersion A | | |
| Comparative | 1 | 100 parts of | | 3 parts of |
| Example 3 | | aqueous | | Desmodur ®2802 |
| | | polyurethane | | |
| | | dispersion A | | |
| Comparative | 0 | 100 parts of | | |
| Example 4 | | aqueous | | |
| | | polyurethane | | |
| | | dispersion A | | |
| Example 4 | 0.85 | 100 parts of | 5 parts of | 6 parts of |
| | | Impranil ®1701 | Imprafix ®2794 | Desmodur ®2802 |
| Comparative | 0.14 | 100 parts of | 5 parts of | 1 part of |
| Example 5 | | Impranil ®1701 | Imprafix ®2794 | Desmodur ®2802 |
| Comparative | 0 | 100 parts of | 5 parts of | |
| Example 6 | | Impranil ®1701 | Imprafix ®2794 | |
| Comparative | 0 | 100 parts of | | |
| Example 7 | | Impranil ®1701 | | |
| Example 5 | 1.2 | 50 parts of | 3 parts of | 6 parts of |
| | | aqueous | Imprafix ®3025 | Desmodur ®2802 |
| | | polymethane | | |
| | | dispersion A, 50 | | |
| | | parts of | | |
| | | Impranil ®1701 | | |
| Comparative | 0 | 50 parts of | 3 parts of | |
| Example 8 | | aqueous | Imprafix ®3025 | |
| | | polymethane | | |
| | | dispersion A, 50 | | |
| | | parts of | | |
| | | Impranil ®1701 | | |
| Comparative | 0.2 | 50 parts of | 3 parts of | 1 part of |
| Example 9 | | aqueous | Imprafix ®3025 | Desmodur ®2802 |
| | | polymethane | | |
| | | dispersion A, 50 | | |
| | | parts of | | |
| | | Impranil ®1701 | | |
| Comparative | 0 | 50 parts of | | |
| Example 10 | | aqueous | | |
| | | polymethane | | |
| | | dispersion A, 50 | | |
| | | parts of | | |
| | | Impranil ®1701 | | |
| Comparative | / | 100 parts of | 5 parts of | 3 parts of |
| Example 11 | | Impranil ®DLU | Imprafix ®2794 | Desmodur ®2802 |

Note:
parts in Table 1 are parts by weight

In the present invention, the composition is used to prepare a film, and the weight/volume ratio of the film is tested to characterize the acid-resistance and the alkali-resistance, particularly the hot acid-resistance and the hot alkali-resistance of the film formed with the composition. An article is prepared by using a superfine fiber non-woven fabric impregnation process, and the appearance of the article is observed.

The Process for Preparing the Films with Compositions of Examples 1-5 and Comparative Examples 1-11 and the Test Method for the Weight/Volume Ratio of the Films
1. The compositions of Examples and Comparative examples were obtained by mixing the components of the compositions according to Table 1 uniformly, and the viscosity of the compositions was adjusted to about 5000 mPa·s by using Borchi Gel®ALA.

The composition was scraped on a flat and smooth surface with a film scraper to prepare a wet film with the thickness of 500 μm, and a dry film sample was obtained by drying the wet film at 50° C. for 30 minutes and at 150° C. for 3 minutes in sequence;
2. A half of the dry film was taken and a piece of 5 cm*2 cm was cut therefrom. The thickness and the weight of said piece of the dry film were measured, wherein the thickness of the film sample was recorded as T₀, and the weight of the film sample was recorded as S₀;
3. After the weight of the dry film was measured, the dry film was put into a test dyeing cup. A NaOH solution with the concentration of 1.5% was added in an amount 15 times as large as the weight of the dry film. The test dyeing cup was put into a laboratory sample dyeing machine, and a high-temperature alkali treatment was carried out according to the following process conditions:

Heating from room temperature to 90° C. at a heating speed of 4° C./min, keeping at 90° C. for 15 minutes, and cooling from 90° C. to 50° C. at a cooling speed of 3° C./min. The laboratory sample dyeing machine was Model DYE-24 commercially available from Shanghai Qianli automation equipment Co., Ltd.;
4. After the treatment in the high-temperature alkali condition was completed, the film was taken out and cleaned (if the film was damaged, the subsequent steps were not needed). The film was dried by absorbing water with paper. The film was put into the test dyeing cup again, and an acetic acid solution with a pH of 4 was added in an amount 15 times as large as the weight of the film. The test dyeing cup was put into the laboratory sample dyeing machine, and a high-temperature acid treatment was carried out according to the following process conditions:

Heating from room temperature to 80° C. at a heating speed of 3° C./min, heating from 80° C. to 130° C. at a heating speed of 1° C./min, keeping at 130° C. for 40 minutes, then cooling from 130° C. to 80° C. at a cooling speed of 1° C./min, and cooling from 80° C. to 50° C. at a cooling speed of 3° C./min;
5. After the treatment in the high-temperature acid condition was completed, the film was taken out and cleaned, and the length, width and thickness of the film was measured, wherein the length of the treated film sample was recorded as L₁, the width of the treated film sample was recorded as W₁, the thickness of the treated film sample was recorded as T₁, and the swelling ratio R was calculated according to the following calculation formula:

R=(L₁*W₁*T₁/(5*2*T₀))*100%−1
6. The film obtained after the treatment through the above steps was dried by absorbing water with paper, and then dried for 10 minutes in a drying oven at 90° C. The dried film was placed in a constant temperature and humidity room for adjustment for 24 hours, and then the weight of the treated film sample was measured and recorded as S₁. The weight loss rate Z of the sample was calculated according to the following calculation formula:

Z=((S₀−S₁)/S₀)*100%
7. The weight/volume ratio of the film sample obtained after the treatment through the above steps was calculated according to the following calculation:

weight/volume ratio=((1−Z)/(1+R))*100

The greater the weight/volume ratio was, the better the acid and alkali resistances of the film formed with the composition under the above-described treatment conditions were. When the weight/volume ratio of the film formed with the composition was greater than 80, the acid and alkali resistances of the film were excellent, and the composition was particularly suitable for fiber impregnation applications.

### Film Test Results

Table 2 lists the test results for the weight/volume ratios of the films formed with the compositions of Examples 1-5 and Comparative examples 1-11.

TABLE 2
Weight/volume ratio test result

| Example and | Swelling | Weight loss | Weight/volume |
|---|---|---|---|
| Comparative Example | ratio R (%) | rate Z (%) | ratio |
| Example 1 | 19 | 4.7 | 80.1 |
| Example 2 | 19.9 | 3 | 80.9 |
| Example 3 | 12.9 | 2.2 | 86.6 |
| Comparative | 22.2 | 5.0 | 77.8 |
| Example 1 | | | |
| Comparative | 30.8 | 4.6 | 72.9 |
| Example 2 | | | |
| Comparative | 30.9 | 3.33 | 73.9 |
| Example 3 | | | |
| Comparative | 80.5 | film was | / |
| Example 4 | | damaged | |
| Example 4 | 4.2 | 1.4 | 94.6 |
| Comparative | 76.5 | 5.7 | 53.4 |
| Example 5 | | | |
| Comparative | 104.6 | 5 | 46.5 |
| Example 6 | | | |
| Comparative | film was | film was | / |
| Example 7 | damaged | damaged | |
| Example 5 | 17.7 | 2.1 | 83.2 |
| Comparative | 25.7 | 3.1 | 77.1 |
| Example 8 | | | |
| Comparative | 41.6 | 2.82 | 68.6 |
| Example 9 | | | |
| Comparative | film was | film was | / |
| Example 10 | damaged | damaged | |
| Comparative | film was | film was | / |
| Example 11 | damaged | damaged | |

It could be seen from the results of Examples 1-5 that the weight/volume ratios of the films formed with the compositions of the present invention comprising the aqueous polyurethane dispersion having a carboxyl group, the crosslinking agent having a blocked or unblocked isocyanate reactive group and the crosslinking agent having a carboxyl reactive group were more than 80, which indicated that the films formed with the compositions of the present invention had good acid and alkali resistances.

Although the comparative compositions of Comparative Examples 1, 5 and 9 contained the aqueous polyurethane dispersion having a carboxyl group, the crosslinking agent having a blocked or unblocked isocyanate reactive group and the crosslinking agent having a carboxyl reactive group, the molar ratios of the carboxyl reactive group to the carboxyl group of the comparative compositions were less than equal to 0.5, and the weight/volume ratios of the films formed with the comparative compositions were less than 80, indicating that the films formed with the comparative compositions had poor acid and alkali resistances.

The comparative compositions of Comparative Examples 2, 6 and 8 did not contain the crosslinking agent having a carboxyl reactive group, the comparative composition of Comparative Example 3 did not contain the crosslinking agent having an isocyanate reactive group, the comparative compositions of Comparative Examples 4, 7 and 10 neither contained the crosslinking agent having a carboxyl reactive group nor the crosslinking agent having an isocyanate reactive group, the weight/volume ratios of the films formed with the above comparative compositions were less than 80, or the films formed with the above compositions were damaged, that was to say, the films formed with the above comparative compositions had poor acid and alkali resistances.

The aqueous polyurethane dispersion in the comparative composition of Comparative Example 11 had no carboxyl group, and the film formed with the comparative composition was damaged, i.e., the film formed with the comparative composition had poor acid and alkali resistances.

### Impregnation Treatment of Superfine Fiber Nonwoven Fabric

1. The components of the compositions were uniformly mixed according to the compositions of Example 6 and Comparative Example 12, respectively. The viscosity of the compositions was adjusted with the LYOPRINT® PTF thickener to about 50 mPa·s (viscosity measurement condition: Brookfield viscometer, 63# rotor, 100 rpm). The superfine fiber nonwoven fabric was completely immersed in the composition. The superfine fiber nonwoven fabric was taken out and the excess slurry was removed by rolling with a laboratory rolling mill. Then superfine fiber nonwoven fabric was dried in an oven at 70° C., and finally cured in an oven at 150° C. for 3 minutes to obtain a superfine fiber nonwoven fabric sample;
2. After the weight of the superfine fiber non-woven fabric sample obtained from the treatment in the previous step 1 was measured, the fabric sample was put into a test dyeing cup. A NaOH solution with the concentration of 1.5% was added in an amount 15 times as large as the weight of the fabric sample. The test dyeing cup was put into a laboratory sample dyeing machine, and a high-temperature alkali treatment was carried out according to the following process conditions:

Heating from room temperature to 90° C. at a heating speed of 4° C./min, keeping at 90° C. for 30 minutes, and cooling from 90° C. to 50° C. at a cooling speed of 3° C./min. The laboratory sample dyeing machine was Model DYE-24 commercially available from Shanghai Qianli automation equipment Co., Ltd.;
3. After the treatment in the high-temperature alkali condition was completed, the fabric sample was taken out and cleaned (if the film was damaged, the subsequent steps were not needed). The film was dried by absorbing water with paper. The film was put into the test dyeing cup again, and an acetic acid solution with a pH of 4 was added in an amount 15 times as large as the weight of the film. The test dyeing cup was put into the laboratory sample dyeing machine, and a high-temperature acid treatment was carried out according to the following process conditions:

Heating from room temperature to 80° C. at a heating speed of 3° C./min, heating from 80° C. to 130° C. at a heating speed of 1° C./min, keeping at 130° C. for 40 minutes, cooling from 130° C. to 80° C. at a cooling speed of 1° C./min, and cooling from 80° C. to 50° C. at a cooling speed of 3° C./min;
4. After the high-temperature acid treatment, the superfine fiber nonwoven fabric sample was taken out and cleaned, and then dried in a drying oven at 90° C. The superfine fiber nonwoven fabric sample was taken out from the drying oven, and its appearance was observed.

### Example 6

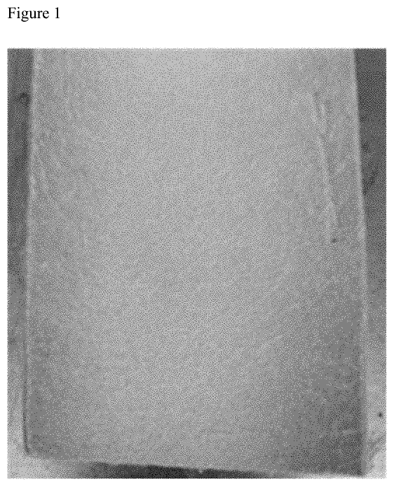

The components of the composition was as follows: 100 parts by weight of aqueous polyurethane dispersion A, 5 parts by weight of Desmodur® 2802, 5 parts by weight of Imprafix® 2794, 205 parts by weight of deionized water and 0.7 part by weight of BYK®333. The solid content of the composition was about 13 wt %. The appearance of the superfine fiber nonwoven fabric sample obtained from the above superfine fiber nonwoven fabric impregnation treatment was shown in FIG. 1.

### Comparative Example 12

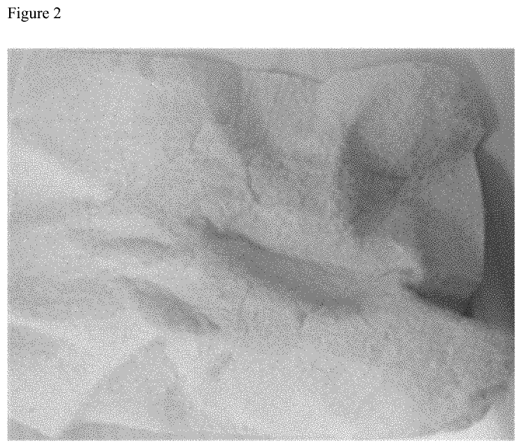

The components of the comparative composition was as follows: 100 parts by weight of Impranil® DLU, 2 parts by weight of Desmodur® 2802, 5 parts by weight of Imprafix® 2794, about 345 parts by weight of deionized water and 0.7 part by weight of BYK 333. The solid content of the composition was about 13 wt %. The appearance of the superfine fiber nonwoven fabric sample obtained from the above superfine fiber nonwoven fabric impregnation treatment was shown in FIG. 2.

As can be seen from FIGS. 1 and 2, compared with Comparative Example 12, the superfine fiber nonwoven fabric sample prepared from the composition of Example 6 was smoother and crease-free, indicating that the composition of Example 6 was more suitable for the superfine fiber impregnation process than the comparative composition of Comparative example 12.

It will be apparent to those skilled in the art that the present invention is not limited to the specific details described above, and that the present invention may be embodied in other specific forms without departing from the spirit or essential characteristics thereof. The described embodiments are therefore to be considered in all respects as illustrative and not restrictive. The scope of the invention is thus indicated by the appended claims rather than by the foregoing description. Therefore, any modification, as long as it falls within the meaning and scope of the claims equivalent, should be considered as belonging to the present invention.

1. A composition, comprising:
at least one aqueous polyurethane dispersion having a carboxyl group;
at least one crosslinking agent having an isocyanate reactive group;
at least one crosslinking agent having a carboxyl reactive group; and
optionally an additive;
wherein, an amount of the carboxyl groups in said aqueous polyurethane dispersion is more than 0.05 wt %, based on a total amount of said aqueous polyurethane dispersion; an amount of said crosslinking agent having an isocyanate reactive group is 0.2 wt %-10 wt %, based on a total amount of said composition; a molar ratio of the carboxyl reactive groups to the carboxyl groups of said composition is more than 0.5.

2. The composition according to claim 1, wherein said aqueous polyurethane dispersion comprises a polyurethane obtained by the reaction of a system comprising an isocyanate and a polymer polyol, said polymer polyol comprising a polyether polyol a polycarbonate polyol, or a combination thereof.

3. The composition according to claim 1, wherein said aqueous polyurethane dispersion comprises a polyurethane obtained by the reaction of a system comprising the following components:
A1) at least one polyisocyanate having an isocyanate functionality of not less than 2;
A2) at least two different polytetramethylene ether glycols A2a) and A2b), said A2a) having a number average molecular weight of not more than 1500 g/mol, said A2b) having a number average molecular weight of more than 1500 g/mol; and
A3) at least one anionic or potentially anionic hydrophilic agent having a number average molecular weight of 32 g/mol-400 g/mol and having hydroxyl and carboxyl groups;
B) at least one anionic or potentially anionic hydrophilic agent having an amino functionality;
C) at least one amino functional compound having no hydrophilic group and having a number-average molecular weight of 32 g/mol-400 g/mol; and
D) optionally a neutralizer;
wherein a ratio of the number average molecular weight of said A2a) to the number average molecular weight of said A2b) is 1:9-4:1, and wherein a weight of said A3) is 20%-70% of a total weight of hydrophilic agent of said system.

4. The composition according to claim 3, wherein said A1) polyisocyanate comprises an aliphatic polyisocyanate, a cycloaliphatic polyisocyanate, or a combination thereof, optionally wherein said A1) polyisocyanate comprises hexamethylene diisocyanate, isophorone diisocyanate, or a combination thereof.

5. (canceled)

6. The composition according to claim 3, wherein said A2a) has a number average molecular weight of 400 g/mol-1500 g/mol, said A2b) has a number average molecular weight of more than 1500 g/mol and less than equal to 8000 g/mol, or both.

7. (canceled)

8. The composition according to claim 3, wherein said A3) anionic or potentially anionic hydrophilic agent having a number average molecular weight of 32 g/mol-400 g/mol and having hydroxyl and carboxyl groups is dimethylolpropionic acid.

9. The composition according to claim 3, wherein the ratio of the number average molecular weight of said A2a) to the number average molecular weight of said A2b) is 1:4-7:3.

10. The composition according to claim 3, wherein the weight of said A3) is 20%-60%, based on the total weight of hydrophilic agent of said system.

11. The composition according to claim 3, wherein said B) anionic or potentially anionic hydrophilic agent having an amino functionality is sodium 2-[(2-aminoethyl)amino]ethanesulfonate.

12. The composition according to claim 3, wherein a molar amount of said D) neutralizer is less than equal to 50 mol %, based on a molar amount of said A3).

13. The composition according to claim 1, wherein said crosslinking agent having an isocyanate reactive group is a hydrophilically modified aliphatic isocyanate crosslinking agent.

14. The composition according to claim 1, wherein said crosslinking agent having a carboxyl reactive group is a hydrophilically modified carbodiimide.

15. A process for preparing the composition according to claim 1, comprising: mixing said aqueous polyurethane dispersion having a carboxyl group, said crosslinking agent having an isocyanate reactive group, said crosslinking agent having a carboxyl reactive group and optionally said additive in any manner.

16. The process according to claim 15, wherein the process for preparing said aqueous polyurethane dispersion further comprises the following steps:
I) mixing and reacting A1) at least one polyisocyanate having an isocyanate functionality of not less than 2; A2) at least two different polytetramethylene ether glycols A2a) and A2b), said A2a) having a number average molecular weight of not more than 1500 g/mol, said A2b) as having a number average molecular weight of more than 1500 g/mol; and A3) at least one anionic or potentially anionic hydrophilic agent having a number average molecular weight of 32 g/mol-400 g/mol and having hydroxyl and carboxyl groups to obtain an isocyanate functional pre-polymer;
II) reacting said isocyanate functional pre-polymer, B) at least one anionic or potentially anionic hydrophilic agent having an amino functionality, C) at least one amino functional compound having no hydrophilic group and having a number-average molecular weight of 32 g/mol-400 g/mol, and optionally D) a neutralizer to obtain a polyurethane; and
III) introducing water before, during or after step II) to obtain said aqueous polyurethane dispersion;
wherein a ratio of the number average molecular weight of said A2a) to the number average molecular weight of said A2b) is 1:9-4:1, and wherein a weight of said A3) is 20%-70% of a total weight of hydrophilic agent of said system.

17. A method of producing an article, comprising utilizing the composition according to claim 1 to produce the article.

18. An article comprising a substrate coated or impregnated with the composition according to claim 1, optionally wherein the substrate is a superfine fiber.

19. (canceled)

20. (canceled)

21. A process for producing an article, comprising the following steps:
i) impregnating sea-island type bicomponent superfine fibers into the composition according to claim 1;
ii) taking out and drying sea-island type bicomponent superfine fibers treated in step i), and then impregnating the sea-island type bicomponent superfine fibers into hot alkali or hot water to remove the sea component in the fibers to obtain superfine fibers; and
iii) taking out and drying the superfine fibers to obtain said article.

22. The process according to claim 21, further comprising a step iv) between said step ii) and said step iii) of taking out and drying the superfine fiber treated in the step ii), and then impregnating the superfine fiber in a dye.

23. A process for producing an article, comprising the following steps:
a) impregnating sea-island type bicomponent superfine fibers into hot alkali or hot water to remove the sea component in the fibers to obtain superfine fibers;
b) taking out and drying the superfine fibers treated in step a), and then impregnating the superfine fibers into the composition according to claim 1; and
c) taking out and drying the superfine fibers to obtain said article.

24. The process according to claim 23, further comprising a step d) between said step b) and said step c) of taking out and drying the superfine fiber treated in the step b), and then impregnating the superfine fiber in a dye.
